(19) United States
(12) Patent Application Publication
(10) Pub. No.: US 2014/0052578 A1
(43) Pub. Date: Feb. 20, 2014

(54) PROMOTER SYSTEM AND METHOD FOR PROCESSING PRODUCT AND SERVICE DATA

(71) Applicant: Vernon REDWOOD, Toronto (CA)

(72) Inventor: Vernon REDWOOD, Toronto (CA)

(21) Appl. No.: 13/586,092

(22) Filed: Aug. 15, 2012

(51) Int. Cl. G06Q 30/06

(52) U.S. Cl. CPC G06Q 30/0623
USPC 705/26.61

(57) ABSTRACT

According to embodiments described in the specification, a method, system and apparatus for processing product and service data are provided. The method is performed by a server having a processor interconnected with a memory and a communications interface. The method comprises storing, in the memory, product data defining a plurality of products, the product data including a merchant restriction associated with at least one product; storing, in the memory, a merchant identifier identifying a merchant entity; receiving at the processor, via the communications interface, a request from a merchant device to associate selected product data with the merchant identifier; determining at the processor whether the request is permissible, based on the merchant restriction; and when the determination is affirmative, storing the association of the selected product data with the merchant identifier in the memory.

### FIELD

The specification relates generally to data management, and specifically to a method, system and apparatus for processing product and service data.

### BACKGROUND

A large number of merchants (retailers and the like) offer a large number of products and services, often manufactured or otherwise provided by additional entities (e.g. manufacturers, distributors and the like). Data describing the products and services therefore originates in various locations, and obtaining such data by consumer computing devices can be wasteful of computing resources.

### SUMMARY

According to an aspect of the specification, a method is provided in a server having a processor interconnected with a memory and a communications interface. The method comprises: storing, in the memory, product data defining a plurality of products, the product data including a merchant restriction associated with at least one product; storing, in the memory, a merchant identifier identifying a merchant entity; receiving at the processor, via the communications interface, a request from a merchant device to associate selected product data with the merchant identifier; determining at the processor whether the request is permissible, based on the merchant restriction; and when the determination is affirmative, storing the association of the selected product data with the merchant identifier in the memory.

According to another aspect of the specification, a non-transitory computer-readable medium is provided, storing a plurality of computer-readable instructions executable by a processor interconnected with a memory and a communications interface for performing the above method.

According to yet another aspect of the specification, a server is provided, comprising: a memory for storing: product data defining a plurality of products, the product data including a merchant restriction associated with at least one product, and a merchant identifier identifying a merchant entity; a communications interface; and a processor interconnected with the memory and the communications interface; the processor configured to receive, via the communications interface, a request from a merchant device to associate selected product data with the merchant identifier; the processor further configured to determine whether the request is permissible, based on the merchant restriction; and the processor further configured, when the determination is affirmative, to store the association of the selected product data with the merchant identifier in the memory.

### BRIEF DESCRIPTIONS OF THE DRAWINGS

Embodiments are described with reference to the following figures, in which:

FIG. 1 depicts a communication system, according to a non-limiting embodiment;

FIG. 2 depicts a registration and login method for the system of FIG. 1, according to a non-limiting embodiment;

FIG. 3 depicts databases maintained by the server of FIG. 1, according to a non-limiting embodiment;

FIG. 4 depicts a further database maintained by the server of FIG. 1, according to a non-limiting embodiment

FIG. 5 depicts a method of updating product data for the system of FIG. 1, according to a non-limiting embodiment;

FIG. 6 depicts a method of updating merchant inventory data for the system of FIG. 1, according to a non-limiting embodiment;

FIG. 7 depicts an example web page provided during the performance of the method of FIG. 6, according to a non-limiting embodiment;

FIG. 8 depicts another database maintained by the server of FIG. 1, according to a non-limiting embodiment;

FIG. 9 depicts an example web page provided during the performance of the method of FIG. 6, according to another non-limiting embodiment; and

FIG. 10 depicts a method of requesting product and merchant data in the system of FIG. 1, according to a non-limiting embodiment.

### DETAILED DESCRIPTION OF THE EMBODIMENTS

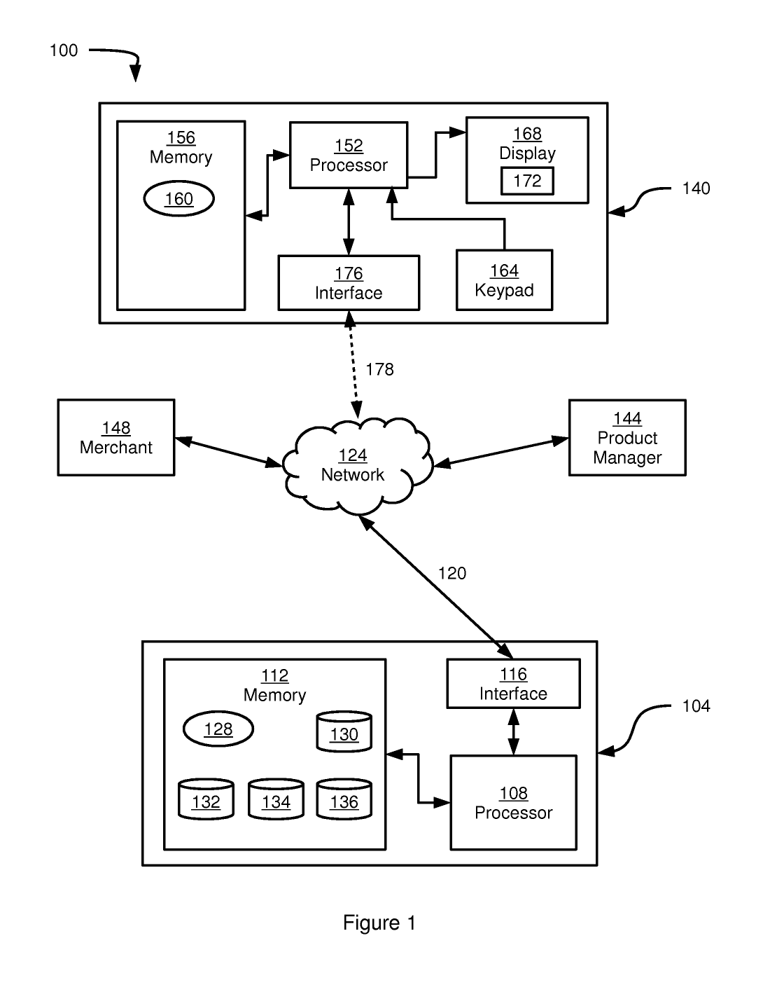

FIG. 1 depicts a communications system 100, which includes various computing devices. In particular, system 100 includes a first computing device in the form of a promoter server 104, also referred to as “server 104”. Server 104 can be based on any known server environment, and thus includes one or more processors and associated components housed in one or more enclosures. It is contemplated that server 104 can also take the form of a desktop computer, laptop computer and the like, or any suitable combination of the above.

In the present example, server 104 includes a processor 108 interconnected with a non-transitory computer readable storage medium such as a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. In the present example, memory 112 includes both a volatile memory and a non-volatile memory.

Server 104 also includes one or more communications interfaces interconnected with processor 108, such as communications interface 116. Communications interface 116 allows server 104 to communicate with other computing devices via a link 120 and a network 124. Network 124 can include any suitable combination of wired and/or wireless networks, including but not limited to a Wide Area Network (WAN) such as the Internet, a Local Area Network (LAN), cell phone networks, WiFi networks, WiMax networks and the like. Link 120 is compatible with at least a portion of network 124. In the present example, link 120 is a wired link, and communications interface 116 is a network interface controller (NIC) which enables communications based on the Ethernet standard. It is contemplated, however, that link 120 can be any suitable combination of wired and wireless links, and that the nature of communications interface 116 can be varied according to the nature of link 120.

Processor 108 can receive input data from one or more input devices (not shown), such as a keyboard and a mouse. Additionally, processor 108 can transmit output data to control one or more output devices, such as a display, speaker and the like. Such input and output devices can be co-located with server 104 and connected to processor 108 via local connections (e.g. Universal Serial Bus, “USB”). In other examples, such input and output devices can be located at a further computing device (not shown) connected to server 104 via network 124 and link 120. When the input and output devices are connected to server 104 via a further computing device, the input and output data is routed through communications interface 116. In some examples, input and output devices can be provided both locally and connected to a further computing device, and server 104 can receive input data from either the local input devices or the remote input devices, or both, and can control either the local output devices or the remote output devices, or both.

The components of server 104 are interconnected via a communication bus (not shown), and are housed within one or more enclosures (not shown). Server 104 receives electrical power from a power source (not shown).

In general, and as will be discussed in greater detail below, promoter server 104 is configured to receive and process data relating to products and merchants, and to respond to requests related to such data from other computing devices. To that end, memory 112 stores a plurality of computer readable instructions executable by processor 108. The computer readable instructions include, for example, an operating system and a variety of applications.

In particular, memory 112 stores a promoter application 128, also referred to herein as “application 128”. When processor 108 executes the instructions of application 128, processor 108 is configured to perform various functions specified by application 128, as will be discussed below in greater detail. Memory 112 also stores a product information database 130, a product manager identifier database 132, a merchant identifier database 134, and a merchant inventory database 136. The contents of the above databases, which will be discussed below, is processed by processor 108 during the execution of application 128.

System 100 also includes a plurality of other computing devices, including at least one consumer computing device 140, at least one product manager computing device 144, and at least one merchant computing device 148.

Consumer device 140, manager device 144 and merchant device 148 can be desktop computers, laptop computers, tablet computers, hand-held communication devices (e.g. tablet computers, cellular telephones, smartphones, Personal Digital Assistants (“PDAs”), media (e.g. MP3) players) and the like. As a result, devices 140, 144 and 148 include processors, memories, input devices, output devices and communications interfaces housed within enclosures. The components of consumer device 140, shown schematically in FIG. 1, will be discussed below.

In the present example, consumer device 140 includes a processor 152 interconnected with a non-transitory computer readable storage medium such as a memory 156. As mentioned in connection with memory 112 above, memory 156 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory.

Memory 156 stores a plurality of computer readable instructions executable by processor 152, including, for example, an operating system and a variety of applications. One such application is a web browser application 160. When processor 108 executes the instructions of application 160, processor 152 is configured to perform various functions in communication with server 104, as will be discussed below.

Consumer device 140 also includes one or more input devices interconnected with processor 152. Such input devices are configured to receive input and provide data representative of such input to processor 152. Input devices can include, for example, a keypad 164, which receives input in the form of the depression of one or more keys, and provides data representative of such input to processor 152 (for example, as an American Standard Code for Information Interchange (ASCII) value for each of the depressed keys). Keypad 164 can be a full QWERTY keypad, a reduced QWERTY keypad or any other suitable arrangement of keys. Consumer device 148 can include additional input devices (not shown) such as one or more touch screens or touch pads, buttons, light sensors, microphones, cameras or barcode scanners, and the like (not shown).

Consumer device 140 also includes one or more output devices interconnected with processor 152, such as a display 168. Display 168 includes display circuitry 172 controllable by processor 152 for generating interfaces which include representations of data and/or applications maintained in memory 156. Display 168 includes any one of, or any suitable combination of, Cathode Ray Tube (CRT) displays, and flat panel displays (e.g. Liquid Crystal Display (LCD), plasma display, Organic Light Emitting Diode (OLED) display). Circuitry 172 can thus include any suitable combination of display buffers, transistors, LCD cells, plasma cells, phosphors, LEDs and the like. When the input devices of consumer device 148 include a touch screen, the touch screen (not shown) can be integrated with display 168. Consumer device 148 can also include further output devices (not shown), such as a light-emitting indicator (not shown) in the form of an LED, and a motor or other mechanical output device (not shown) for causing communication device 104 to vibrate, a speaker, and the like.

Consumer device 140 also includes a communications interface 176 interconnected with processor 152. Communications interface 176 allows consumer device 140 to communicate with other computing devices via a link 178 and network 124. In the present example, link 178 is a wireless link based on any of the Global System for Mobile communications (GSM), General Packet Radio Service (GPRS), Enhanced Data rates for GSM Evolution (EDGE), third and fourth-generation mobile communication system (3G and 4G), Institute of Electrical and Electronic Engineers (IEEE) 802.11 (WiFi) or other wireless protocols or standards. Link 178 can also include any base stations and backhaul links necessary to connect mobile electronic device 104 to network 140.

Communications interface 176 is selected for compatibility with link 178 as well as with network 124, and thus, in the present example, includes one or more transmitter/receiver assemblies, or radios, and associated circuitry. For example, communications interface 176 can include a first radio for enabling communications over a WiFi network, and a second radio for enabling communications over one or more mobile telephone networks (e.g. 3G networks). In other examples, link 178 can be a wired link and communications interface 176 can be selected accordingly.

The various components of consumer device 140 are contained within a housing (not shown) comprising any suitable combination of materials (e.g. aluminum, plastics, and the like). The components of mobile electronic device 104 are interconnected via a communication bus (not shown), and receive electrical power from a power source (not shown). In some examples, certain components need not be contained within the same housing. For example, display 168 can be contained in a separate housing and connected to processor 152 via a local connection (e.g. Digital Video Interface (“DVI”)).

Various configurations for devices 144 and 148 will now occur to those skilled in the art. The configurations of devices 144 and 148 can be similar to device 140, or can be varied from the configuration of device 140 as discussed above. As mentioned above, there can be more than one of each of devices 140, 144 and 148. When a plurality of such devices are present in system 100, it is not necessary for all devices to have the same configuration. For example, different merchant devices 148 can have different configurations. In general, devices 140, 144 and 148 are computing devices configured to communicate with server 104 as will be discussed below.

In the present example, the computing devices shown in FIG. 1 are operated by different entities. Specifically, promoter server 104 is operated by a promoter entity (e.g. an online vendor, auctioneer or the like), manager device 144 is operated by a product manager entity (e.g. an electronics manufacturer or food distributor), merchant device 148 is operated by a merchant entity (e.g. a retailer such as a grocery store or an electronics store), and consumer device 140 is operated by an individual consumer (e.g. a customer of the retailer).

It is contemplated that different product manager, merchant, and consumer entities can operate different devices 140, 144 and 148, respectively. It is also contemplated that a single entity (for example, a particular merchant entity) can operate a plurality of merchant devices 148.

In general, the promoter entity, via the use of promoter server 104, enables the exchange of data between various product manager entities, merchant entities, and consumers. Promoter server 104 thus stores data defining products and services distributed by product managers to merchants, for eventual consumption by consumers. Product manager entities, via registered manager devices 144, can update the stored data, and merchant entities, via registered merchant devices 148, can select from the stored data which products and services are present in their inventories. Consumers, via registered consumer devices 140, can transmit search requests to promoter server 104, and promoter server 104 can return data defining relevant products and services based, in part, on the consumers' locations.

Promoter server 104 is therefore configured, via execution of application 128, to perform functions for registering and authenticating product manager device 144 as well as merchant device 148. Server 104 is also configured to perform functions for processing product data and responding to requests. That is, processor 152 is configured, when executing the instructions of application 128, to interact with and control the other components of server 104 to perform the functions discussed below.

### Registration and Authentication

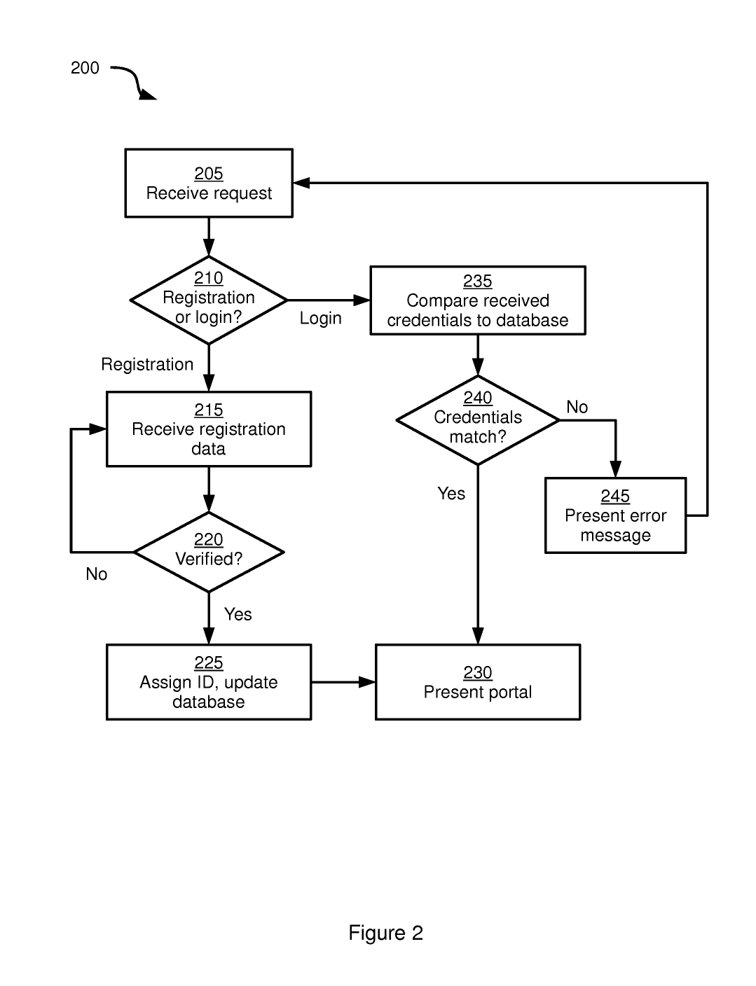

In order for a product manager entity or a merchant entity to update data at promoter server 104 via manager device 144 or merchant device 148, respectively, manager device 144 or merchant device 148 must be authenticated. Turning now to FIG. 2, a method 200 of registering product manager device 144 or merchant device 148 at promoter server 104 is shown.

The blocks of method 200 are performed by server 104, and particularly by processor 108, in conjunction with the remaining components of server 104, via the execution of application 128. In the example below, the registration of product manager device 144 will be discussed, although it is contemplated that the same process applies to merchant device 148.

Beginning at block 205, server 104 receives a request from manager device 144. The request is transmitted from manager device 144, via network 124 and link 120, to arrive at interface 116. For example, the request can be generated at device 144 through the execution of a web browser application used to access a login and registration web page hosted by server 104.

At block 210, server 104 is configured to determine whether the request is a registration request or a login request. For example, the requests may be distinguished from one another by identifying the different elements of the above-mentioned web page which were selected to generate the requests. Additionally, a login request may be identified by the presence of a username and password in the request.

If the request received at block 205 is a registration request, server 104 is configured, at block 215, to receive registration data. This can include transmitting a further web page to device 144, including fields for entering data. The data received from device 144 at block 215 can include a name, a physical mailing address, an email address, a telephone number, and the like. The data can also include a password provided by device 144, which will be used in future login requests. When the registration request is received from merchant device 148, the registration data can also include hours of operation of a retail store, and the like.

Having received the registration data, server 104 is then configured, at block 220, perform a verification process. The nature of the verification is not particularly limited, and is generally configured to confirm the identity of the entity operating device 144. For example, verification can include sending a query to a directory service (not shown) to confirm that the name provided by device 144 matches the address provided by device 144 in a directory listing. In another example, a physical postcard can be sent to the registering entity (e.g. to the address received at block 215). The postcard can include a code which must be transmitted from device 144 or 148 to server 104 in order to successfully complete the verification. If the verification process is not successful (for example, if the response from the directory service shows that the name and address provided do not match), server 104 can be configured to return to block 215 and request further registration data. In other examples, server 104 can be configured to terminate method 200 if verification is not successful.

However, if verification at block 220 is successful, the performance of method 200 proceeds to block 225. At block 225, server 104 is configured to assign a product manager identifier and update database 132 with the identifier and the registration data received at block 215. The identifier can be the username used by device 144 in future login requests. In some examples, the identifier can be received as a desired username at block 215. It will now be apparent that if merchant device 148 is being registered rather than manager device 144, at block 225 server 104 is configured to assign a merchant identifier and update database 134.

Following the performance of block 225, server 104 is configured to present a portal to the now-registered device 144 or 148. The nature of the portal presented at block 230 is not particularly limited. For example, the portal can be a web page sent to device 144 or device 148 which includes elements (such as hyperlinks) selectable at device 144 or 148 for causing server 104 to perform further functions. The web page sent at block 230 is selected from a plurality of web pages stored in memory 112 based on the type of device to which the web page is to be sent. That is, device 144 receives a manager portal web page, which is different from a merchant portal web page sent to device 148.

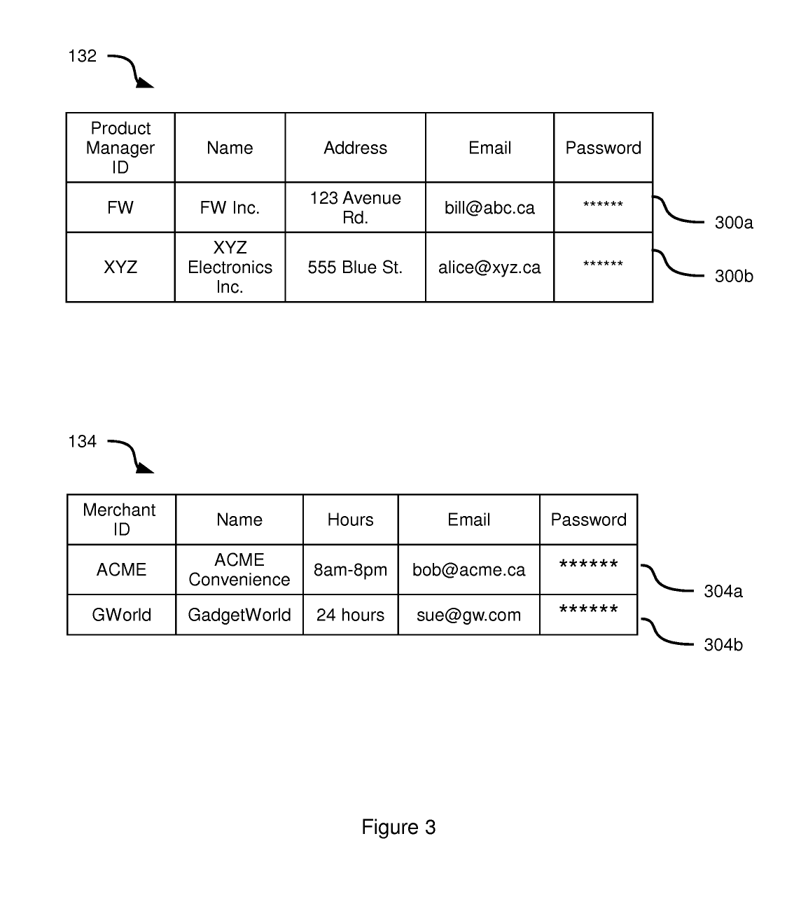

Referring now to FIG. 3, examples of databases 132 and 134 are shown after registration of two product managers and two merchants. It is contemplated that while registration of devices 144 and 148 is discussed above, the registration of method 200 can instead relate to accounts maintained at server 104 that can be accessed from any computing device. Thus, the database records shown in FIG. 3 do not make reference to any particular device.

As seen in FIG. 3, database 132 includes a record 300a, 300b, and so on, for each registered product manager. Each record 300 includes a product manager identifier (ID), a name of the product manager entity, a mailing address of the product manager, an email address of the product manager, and a password (the passwords are hidden in FIG. 3, though this is not mandatory). Additional data can also be included in records 300, such as a device identifier for device 144, and the like.

Database 134 includes a record 304a, 304b, and so on, for each registered merchant. Each record 304 includes a merchant identifier, a name of the merchant entity, the merchant entity's hours of operation (that is, the hours the merchant is open for business), an email address of the merchant, and a password. It is contemplated that additional data can be included in each record 304, such as a mailing address, a device identifier for device 148, and the like.

Referring again to FIG. 2, and returning to block 210, if the request received at block 205 is determined by server 104 to be a login request rather than a registration request, the performance of method 200 proceeds to block 235 rather than block 215. At block 235, server 104 is configured to compare the username (i.e. identifier) and password received at block 205 with databases 132 and 134. At block 340, server 104 is configured to determine whether the received login credentials match any records in databases 132 or 134. When the determination is negative, server 104 is configured to present an error message to device 144 and return to block 205.

When the determination at block 240 is affirmative, however, the login is successful (that is, device 144 has been successfully authenticated as registered device, or as having access to a registered account) and the performance of method 200 proceeds to block 230, described above.

It is contemplated that a consumer can also register with server 104, via device 140, in a manner similar to that discussed above in connection with FIG. 2. In such examples, server 104 can maintain an additional database of consumer identifiers.

### Product Master List

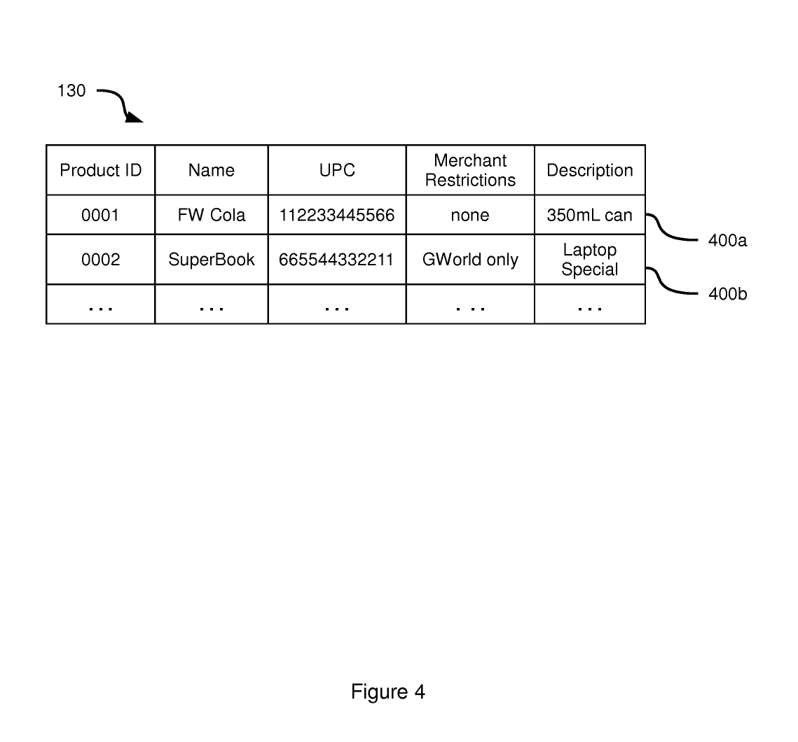

As mentioned earlier, server 104 maintains a product information database 130, which contains data defining a master list of a plurality of products and services. Turning now to FIG. 4, an example database 130 is shown. Database 130 includes a record 400a, 400b, and so on, for each product or service. Each record includes a collection of data describing a product or service. In FIG. 4, two example products are shown: A 350 mL can of cola, and a laptop computer.

The data included in each record can includes, as shown in FIG. 4, a product identifier, a product name, a Universal Product Code (UPC), merchant restrictions (which are used to control which merchants are permitted to add the product to their inventories, as will be discussed in greater detail below), and a product description. The contents of the product description is not particularly limited, and can include any suitable information concerning the product. For example, the product description can include indications of dimensions, available colours and other variable product attributes, product weight, product features (e.g. technical specifications for an electronic device), product images, and the like. It is also contemplated that the above description-related data can be separated into a plurality of fields in a record 400.

In addition, each record 400 can include further data not shown in FIG. 4, either in addition to or instead of the data shown in FIG. 4. For example, a different product code can be used instead of a UPC, or a product code can simply be omitted. As a further example, each record 400 can include price data (either a particular mandated price, or a price range). As still another examiner, each record 400 can include a product manager identifier, to indicate which products or services are associated with which product manager accounts. As yet another example, each record 400 can include one or more category identifiers or other keywords associated with the product (for example, an “electronics” category, or a “food” category).

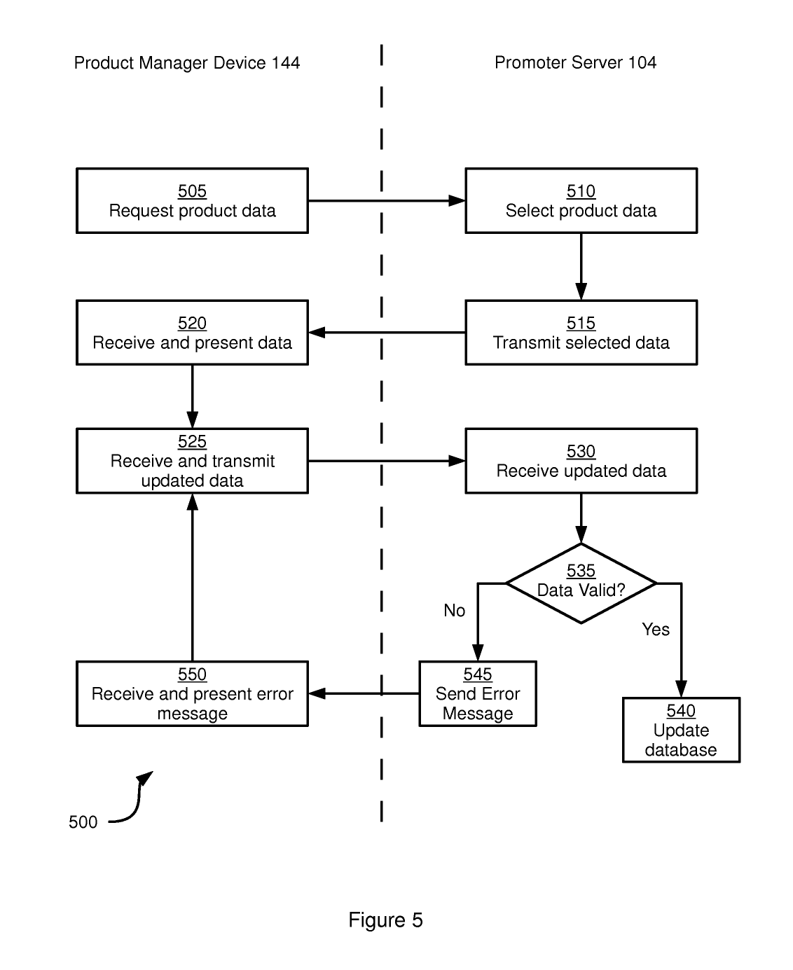

The contents of database 130 can be updated by a product manager entity, via device 144, as will be discussed below in connection with FIG. 5.

FIG. 5 depicts a method 500 of updating data in database 130. The blocks of method 500 are divided between manager device 144 and server 104. In other words, manager device 144 is configured, by execution of (for example) a browser application to access web pages hosted by server 104, to perform certain blocks of method 500, while server 104 is configured, via execution of application 128, to perform other blocks of method 500.

Beginning at block 505, device 144, having successfully registered with server 104 and logged in at server 104 (via the process shown in FIG. 2), transmits a request for product data. The request includes data identifying at least some of the records in database 130. The nature of the request is not particularly limited. For example, the request can be a request for all available data in database 130, or for data relating to products identified by certain categories or keywords, or for only specific products identified by product names. Other types of requests will now be apparent to those skilled in the art.

At block 510, server 104 is configured to receive the request sent by device 144 and to select product data based on the product manager identifier associated with device 144 and on the contents of the request. In the present example, it will be assumed that the request is a request for all available product data from database 130. Server 104 therefore selects both records 400 shown in FIG. 4. It is contemplated that in some examples, some products may not be associated with certain product manager accounts, and may therefore not be selected at block 510 (that is, device 144 may not have access to the entire contents of database 130).

At block 515, server 104 is configured to transmit the selected product data to device 144, for example in the form of a web page with editable fields corresponding to the fields shown in FIG. 4. At block 520, device 144 is configured to receive the selected data and present the data on a display (not shown). At block 525, device 144 is configured to receive input data (for example, from a keyboard and mouse, or other input devices) representing updated product data, and to transmit the updated product data to server 104. For example, the updated product data can include a new price for the “FW Cola” product shown in FIG. 4.

At block 530, server 104 is configured to receive the updated data and determine, at block 535, if the updated data is valid. For example, device 144 may not be permitted to update certain fields of records 400, or certain fields (such as a price field) may require data to be presented in a predetermined format. If the received data is valid, server 104 is configured to update database 130 with the updated data at block 540. Otherwise, server 104 is configured to notify device 144 of an error at block 545. Upon receiving the error notification at block 550, device 144 can be configured to return to block 525 for receiving further updated data (such as a corrected version of the updated data that lead to the error message).

### Merchant Inventory, Updating and Validation

As seen above, server 104 is therefore configured to maintain data defining one or more products and services, received from one or more product manager devices. As also seen above, server 104 is additionally configured to maintain data identifying one or more merchants, received from one or more merchant devices.

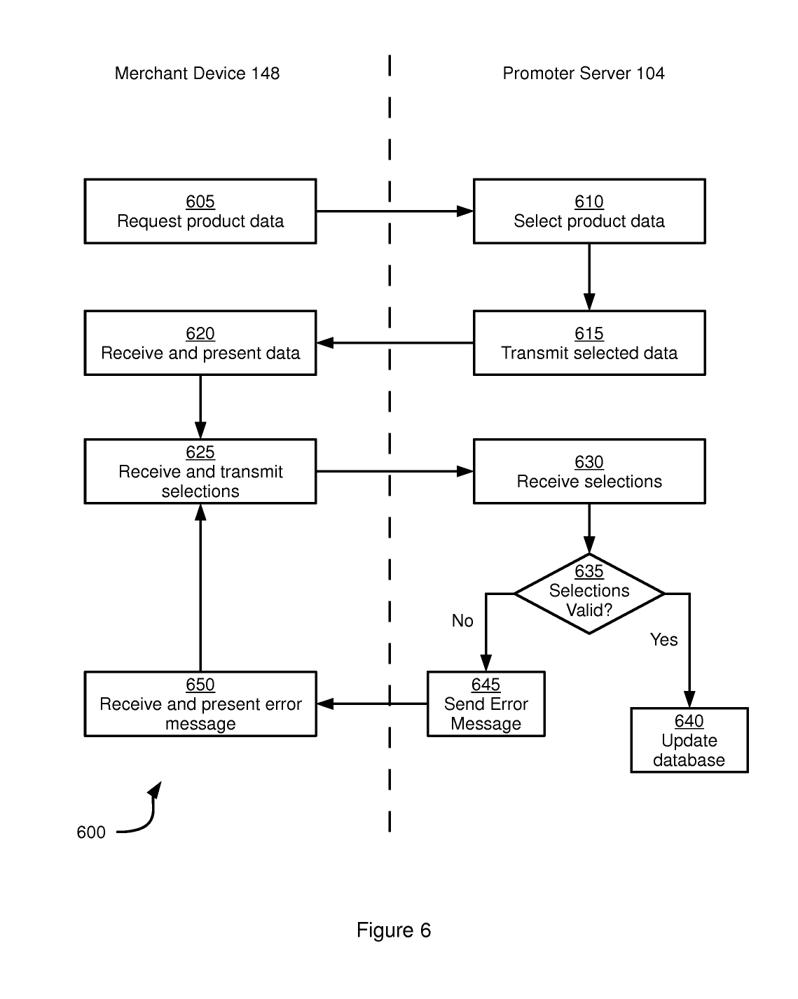

As will now be discussed in connection with FIG. 6, server 104 is additionally configured to receive and respond to requests from merchant device 148 for defining a merchant inventory maintained in database 136. Briefly, a merchant inventory is a series of associations between product data in database 130 and merchants identified in database 134. In other words, the inventory of a given merchant entity is defined by the set of products defined in database 130 for which memory 112 contains associations with the merchant identifier of that given merchant entity. The merchant inventory is stored in memory 112 in database 136.

Turning to FIG. 6, a method 600 of updating data in database 136 is shown. The blocks of method 600 are divided between merchant device 148 and server 104. Thus, merchant device 148 is configured, for example, to perform certain blocks of method 600 by executing a web browser application in order to access web pages hosted by server 104. Server 104, meanwhile, is configured to perform other blocks of method 600 by executing application 128. It is assumed that prior to the performance of method 600, merchant device 148 has successfully registered and logged in as discussed above in connection with FIG. 2.

The performance of block 605 by merchant device 148 is as described above in connection with block 505. Briefly, merchant device 148 transmits a request to product data. The request is received by server 104 (specifically, at communications interface 116) at block 610, and server 104 selects product data from database 130 at block 610 for transmission to merchant device 148 at block 615. As discussed above in connection with block 510, the selection of product data at block 610 is not particularly limited. In the present example, server 104 selects all products and services in database 130.

Having selected data from database 130, server 104 transmits the selected data to merchant device 148 at block 615. At block 620, merchant device 148 receives the product data from server 104 and presents the data. For example, the data can be presented on a display of merchant device 148. More specifically, server 104 can generate a web page including the selected data and transmit the web page to merchant device 148. Merchant device 148 can then display the web page via the execution of a web browser application on merchant device 148.

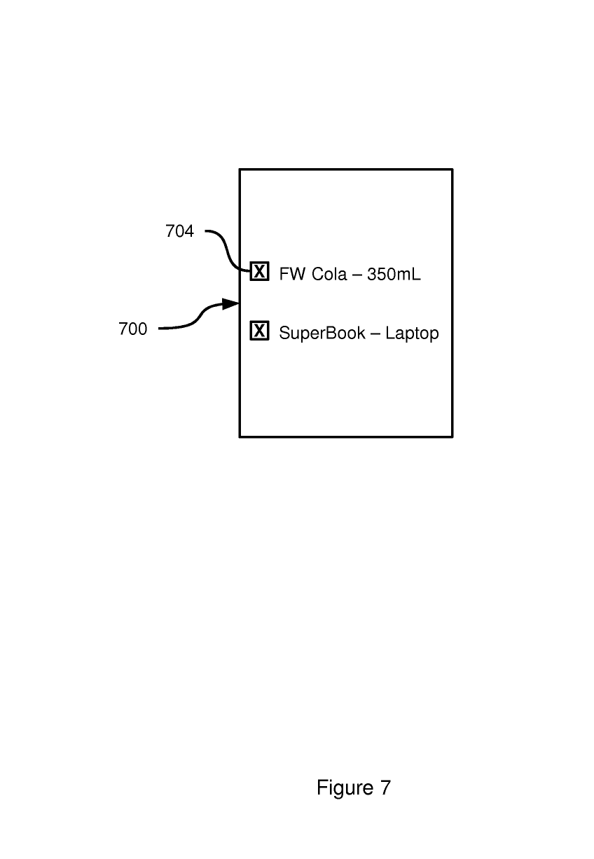

Proceeding to block 625, merchant device 625 is configured to receive input data (for example, from a keyboard, mouse or other input device) representing a selection of at least one product from the product data received at block 620. The selections received at block 625 are selections of products to be associated with the merchant entity operating merchant device 148. For example, as shown in FIG. 7, the web page mentioned above can be shown on a display 700 of merchant device 148 and can include selectable check boxes 704 associated with each product. As seen in FIG. 7, both checkboxes are marked with an “X”, indicating that at block 625, merchant device has received selections of both the FW Cola and SuperBook products. The selections received at block 625 are transmitted to server 104, and received at server 104 at block 630. It is contemplated that a wide variety of selection mechanisms can be provided at block 625 instead of, or in addition to, check boxes 704. For example, the product name can be selectable, or selectable buttons can be provided for each product. Other variations will now occur to those skilled in the art.

In other words, server 104 is configured to receive a request from merchant device 148 to associate the selected product data with the merchant identifier associated with merchant device 148. That is, the request received at block 630 is a request to add the selected products to the merchant inventory associated with that merchant identifier. This may be because, for example, the merchant entity wishes to indicate that it sells the selected products.

Having received the request including the selections at block 630, server 104 is configured, at block 635, to determine whether the selections are valid. The determination at block 635 can be performed by comparing the merchant identifier associated with device 148 with any merchant restrictions stored in database 130 in association with the selected products.

In the present example, where both of the products shown in FIG. 4 were selected, it will be assumed that device 148 is associated with the merchant identifier “ACME”. Thus, at block 635, server 104 is configured to compare the merchant identifier “ACME” with the merchant restrictions stored in database 130 for each of the selected products. Referring briefly to FIG. 4, the FW Cola product has no restrictions, while the SuperBook product is restricted to a single merchant (Gadget World), having the identifier “GWorld”. It is contemplated that other forms of merchant restrictions can also be provided in database 130. In addition to no restrictions and restrictions to one or more specific identified merchants, database 130 can also contain merchant restrictions in the form of prohibited merchants. Thus, a product can be available for selection by any merchant except the one or more specific merchant identifiers stored in database 130 in association with the product.

Returning to FIG. 6, server 104 is therefore configured to determine that the selection of the FW Cola product is valid, while the selection of the SuperBook product is not valid, because the selection was not received from a device associated with the merchant identifier shown in FIG. 4.

For each product, following a positive determination at block 635, server 104 is configured to update merchant inventory database 136 at block 640. Following a negative determination, server 104 is configured to send an error message to device 148 at block 645. Following the receipt of the message at block 650, device 148 may return to block 625.

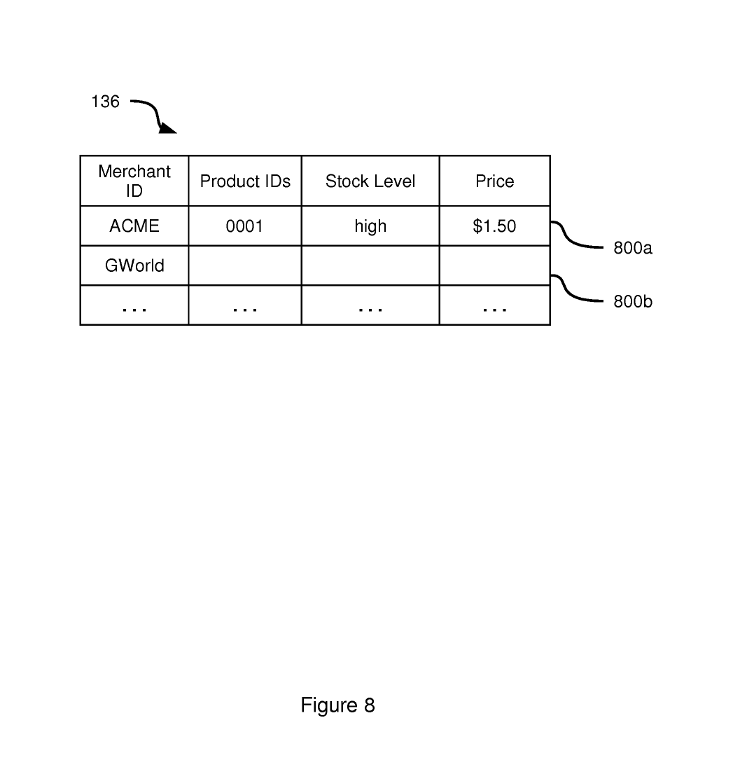

Turning now to FIG. 8, an example merchant inventory database 136 is shown, following the performance of method 600 described above. Database 136 includes a record 800a, 800b, and so on, for each merchant identifier included in database 134. For each merchant identifier, database 136 includes product identifiers of successful validated products selected by a device associated with that merchant identifier. That is, each record 800 can include a plurality of product identifiers and corresponding stock levels, prices and the like. It is contemplated that database 136 can take a variety of forms. For example, a plurality of records may be stored in database 136 for each merchant identifier (one record for each product identifier associated with that merchant identifier, for example). Thus, in the present example, record 800a includes the product identifier “0001”, which identifies the FW Cola product. Of note, record 800a does not include the SuperBook product, even though it was selected by device 148 at block 625. This is because device 148 was not permitted to select the SuperBook product, and the validation at block 635 therefore failed.

Thus, it can be seen that database 136 stores data defining the inventory of a merchant (for example, the items stocked in a retail location). Database 136 can include a variety of additional data, such as stock level and price. Stock level can be indicated in absolute numbers (e.g. thirty units of a given product), in ranges (e.g. between twenty and forty units), or in levels, as shown in FIG. 8. The levels can be predetermined and set by either an operator of server 104, or by a product manager via device 144. The levels can be indications of numerical ranges (e.g. “high” may mean more than fifty units, “medium”, may mean between ten and fifty units, and “low” may mean less than ten units).

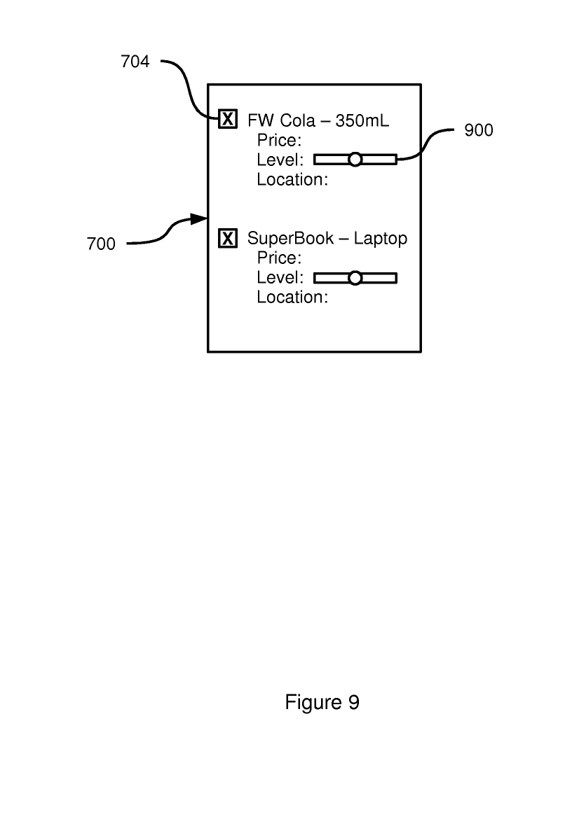

Other data that can be included in records 800 includes location within a retail store (e.g. aisle 3), a special price and expiry of the special price, and the like. It is contemplated that any of the data shown in database 136 can be transmitted by device 148 to server 104 at block 625. Thus, referring to FIG. 9, server 104 can be configured to send a more detailed web page to device 148 at block 615 for presentation on display 700, thus allowing device 148 to enter the additional data. For example, in FIG. 9 the same two products are shown as in FIG. 7, along with check boxes 704. However, several fields are shown in connection with each product, including price, stock level, and location fields. The level fields are shown with sliders 900 which are selectable to indicate a level of stock for the corresponding product. In other examples, as mentioned above, the level fields can be numerical fields. In still other examples, colour-coded radio buttons can be provided (e.g. green for high stock levels, yellow for medium, and red for low or no stock).

As illustrated by the above examples, database 136 can include various merchant data associated with a product identifier. Such data can be received by server 104 along with product selections at block 630, and validated as with the product selections. For example, price data received at block 630 can be validated by examining database 130 to determine whether any restrictions on price exist. For example, a record 400 can include an indication that merchants must charge a specific price for a product, in which case any deviating price received at block 630 will fail validation.

Server 104 can be configured to generate a web page for transmission to device 148 that includes fields for each of the values stored in records 800. In some examples, server 104 can be configured to omit fields that are subject to restrictions from the web page. For example, if database 130 indicates that no merchant can set the price of a given product, the web page shown in FIG. 9 may omit the “Price” field. Further, server 104 can also be configured to omit products that the requesting merchant is restricted from selecting. Thus, in the above performance of method 600, instead of transmitting product data for both products to device 148, server 104 can be configured to only transmit product data for the FW Cola product at block 615. It is also noted that if, following the addition of a product to a particular merchant inventory record in database 136, a restriction on the associated merchant identifier is added to database 130 for that product, server 104 can be configured to automatically remove that product from the relevant record of database 136, and to transmit a message to merchant device 148 to inform device 148 of the new restriction.

In still other examples, database 130 can include an indication that product codes printed on a physical good (such as the product itself, or a bill of lading for the product) must be entered by device 148 in order to successfully select the product for association with a merchant identifier in database 136. The indication can include a flag indicating that codes are required, or can include the codes themselves. Thus, the validation at block 635 can include determining whether the required product codes have been received from device 148, and, if applicable, whether the codes received match the codes in database 130.

In addition to providing data for database 136 during the performance of method 600, device 148 can also request and update such data after the selection of products. In other words, device 148 can request data from database 136 rather than data from database 130, so as to make changes to already-selected products rather than to select new products.

Thus, in general, server 104 is configured to receive and store data representing merchant inventory by associating product identifiers (which were provided by a product manager) with merchant identifiers, following validation of the requests for such associations.

### Consumer Requests

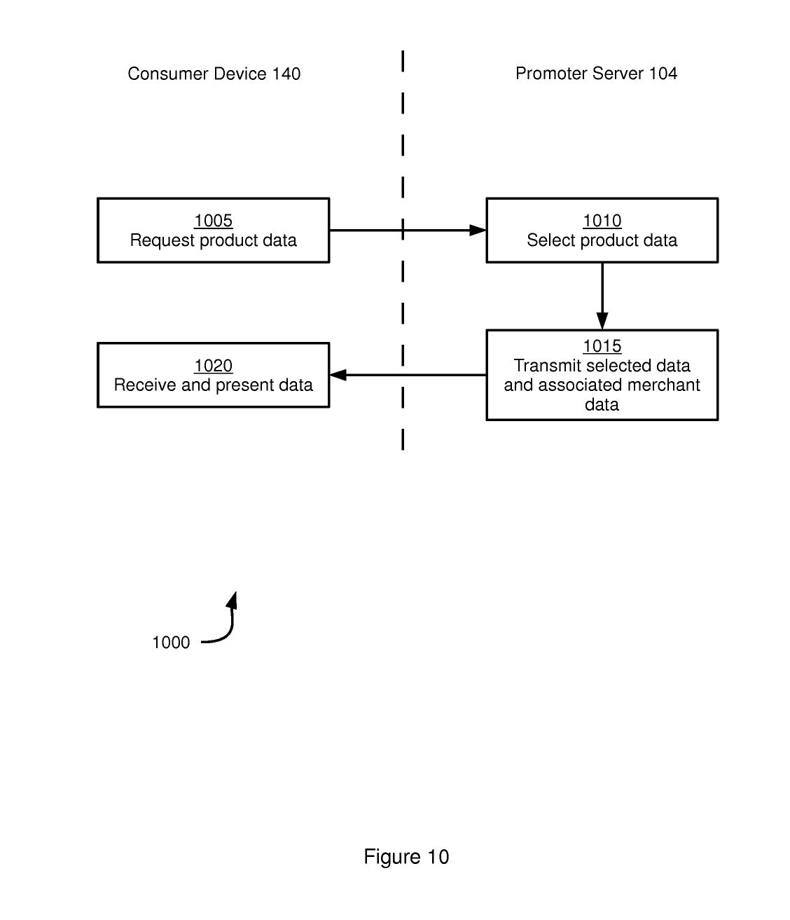

In addition to the functions discussed above, server 104 is configured to respond to requests from consumer device 140, as will be discussed in connection with FIG. 10. FIG. 10 depicts a method 1000 in which server 104 receives and responds to a request from consumer device 140. As mentioned above in connection with methods 500 and 600, some blocks of method 1000 are performed by device 140, while others are performed by server 104.

As mentioned earlier, consumer device 140 need not register with server 104, though registration is possible. Thus, the performance of method 1000 can follow a successful registration and login of device 140, or can happen in the absence of any registration and login of device 140.

At block 1005, device 140 transmits a request for product data to server 104. The nature of the request is not particularly limited. For example, the request can be a request for all products listed in database 130, or can be limited by a search term. At block 1010, server 104 is configured to receive the request and select product data from database 130 based on the request. For example, if the request was a request for all available products, server 104 selects all products defined in database 130 at block 1010. On the other hand, if the request included “electronics” or “laptop” as a search keyword, for example, server 104 is configured to select only relevant products—in this case, the SuperBook product (but not the FW Cola product).

The selection of product data at block 1010 can also be based on the location of device 140. The location of device 140 can be provided in the request send at block 1005. Alternatively, the request can include a desired search location, which may not coincide with the physical location of device 140.

At block 1015, server 104 is configured to transmit the selected product data, along with associated merchant data, to device 140, where the selected data is received at block 1020 for presentation on display 168. That is, server 104 is configured to identify relevant records 400 of database 130 based on the request sent by device 140, and to retrieve merchant data from records 304 of database 134 that contain the relevant product identifiers, indicating that those merchants stock the relevant products. The merchant data retrieved can be limited to data for merchants having a location within a predetermined distance of the location received with the request of device 140.

The product data (which can include product names, descriptions, and the like), as well as the merchant data (which can include pricing, merchant location, and the like) are transmitted to device 140 at block 1015.

Thus, device 140 can obtain, from server 104, a listing of relevant products in a desired geographical area. Having received the product data at block 1020, consumer device 140 can also receive further input data and transmit a request to server 104 for further information concerning a merchant or a product. Server 104 can then transmit a web page generated from data contained in databases 130, 134 and 136.

Various advantages to the above systems and methods will now occur to those skilled in the art. For example, the storage and processing of data by server 104, instead of by separate computing devices operated by different product managers and merchants, leads to increased accuracy of data and reduced storage requirements. In addition, the validation of data and the central agent responding to consumer requests allows consumer devices to conserve resources (needing only to send one request, instead of several to different parties). Other advantages will also occur to those skilled in the art.

Variations to the above methods and systems are contemplated. For example, product data can be received and entered by an operator of server 104 (e.g. via input devices) rather than received from device 144. As another example, server 104 can also receive a request from device 140 for merchant data rather than product data. For example, the request can include a location of device 140 and a search keyword. Server 104 can then retrieve merchant data for any merchants matching the keyword and being located within a predetermined distance of the location, and generate one or more web pages based on the merchant data, for transmission to device 140.

As a further variation, server 104 can store search requests in association with an identifier of device 140, such that device 140 can request a list of previous requests and instruct server 104 to repeat the processing of a given request.

It is contemplated that some entities may be both product managers and merchants. Such entities can be identified in both databases 132 and 134, and a given set of login credentials can therefore grant access to the functionality described above as being available to product managers and merchants. It is also contemplated that the entities identified in databases 132 and 134 are not particularly limited. For example, each merchant identifier in database 134 can identify a company operating many retail locations, a specific retail location, and the like.

In still further variations, method 600 may be modified from the flowchart shown in FIG. 6. In some examples, device 148 can store an Application Programming Interface (API) which configures device 148 to generate requests for server 104. Rather than the web pages discussed above, device 148 can then transmit requests generated based on the API to server 104, without the use of a web browser. For example, blocks 605, 610, 615 and 620 can be omitted, and method 600 can instead begin at block 625. At block 625, device 148 can be configured to generate a request (also referred to as an API call) to add certain product identifiers to database 136. The generation of the request can be initiated in a variety of ways. Example initiation events include an update to a merchant inventory system (not shown) maintained by device 148, which indicates that a new product has been received in stock. Another example initiation event is the scanning of a bar code (or other graphical identifier) on a product by device 148. That is, a processor of device 148 can receive input data from a camera, and be configured to generate and transmit a request to server 104 to add the corresponding product to database 136.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method in a server having a processor interconnected with a memory and a communications interface, comprising:
storing, in the memory, product data defining a plurality of products, the product data including a merchant restriction associated with at least one product;
storing, in the memory, a merchant identifier identifying a merchant entity;
receiving at the processor, via the communications interface, a request from a merchant device to associate selected product data with the merchant identifier;
determining at the processor whether the request is permissible, based on the merchant restriction; and
when the determination is affirmative, storing the association of the selected product data with the merchant identifier in the memory.

2. The method of claim 1, further comprising receiving the product data from a manager device associated with a product manager.

3. The method of claim 1, further comprising receiving the merchant data from a merchant device associated with a merchant entity.

4. The method of claim 1 wherein a merchant restriction comprises a restricted merchant identifier, and wherein the determination comprises determining whether the merchant identifier matches the restricted merchant identifier.

5. The method of claim 4 wherein the determination is negative when the merchant identifier matches the restricted merchant identifier.

6. The method of claim 1, further comprising:
receiving a search request from a consumer device, the search request including a location associated with the consumer device;
selecting response data from the product data, based on the search request; and
transmitting the response data to the consumer device via the communications interface.

7. A server, comprising:
a memory for storing:
product data defining a plurality of products, the product data including
a merchant restriction associated with at least one product, and
a merchant identifier identifying a merchant entity;
a communications interface; and
a processor interconnected with the memory and the communications interface;
the processor configured to receive, via the communications interface, a request from a merchant device to associate selected product data with the merchant identifier;
the processor further configured to determine whether the request is permissible, based on the merchant restriction; and
the processor further configured, when the determination is affirmative, to store the association of the selected product data with the merchant identifier in the memory.

8. The server of claim 7, processor further configured to receive the product data from a manager device associated with a product manager.

9. The server of claim 7, the processor further configured to receive the merchant data from a merchant device associated with a merchant entity.

10. The server of claim 7 wherein a merchant restriction comprises a restricted merchant identifier, and wherein the determination comprises determining whether the merchant identifier matches the restricted merchant identifier.

11. The server of claim 10 wherein the determination is negative when the merchant identifier matches the restricted merchant identifier.

12. The server of claim 1, the processor further configured to receive a search request from a consumer device, the search request including a location associated with the consumer device;
the processor further configured to select response data from the product data, based on the search request; and to transmit the response data to the consumer device via the communications interface.

13. A non-transitory computer-readable medium storing a plurality of computer-readable instructions executable by a processor interconnected with a memory and a communications interface for performing a method comprising:
storing, in the memory, product data defining a plurality of products, the product data including a merchant restriction associated with at least one product;
storing, in the memory, a merchant identifier identifying a merchant entity;
receiving at the processor, via the communications interface, a request from a merchant device to associate selected product data with the merchant identifier;
determining at the processor whether the request is permissible, based on the merchant restriction; and
when the determination is affirmative, storing the association of the selected product data with the merchant identifier in the memory.

14. The non-transitory computer-readable medium of claim 13, wherein the method further comprises receiving the product data from a manager device associated with a product manager.

15. The non-transitory computer-readable medium of claim 13, wherein the method further comprises receiving the merchant data from a merchant device associated with a merchant entity.

16. The non-transitory computer-readable medium of claim 13 wherein a merchant restriction comprises a restricted merchant identifier, and wherein the determination comprises determining whether the merchant identifier matches the restricted merchant identifier.

17. The non-transitory computer-readable medium of claim 16 wherein the determination is negative when the merchant identifier matches the restricted merchant identifier.

18. The non-transitory computer-readable medium of claim 13, wherein the method further comprises:
receiving a search request from a consumer device, the search request including a location associated with the consumer device;
selecting response data from the product data, based on the search request; and
transmitting the response data to the consumer device via the communications interface.
